(19) United States
(12) Patent Application Publication
(10) Pub. No.: US 2008/0126439 A1
(43) Pub. Date: May 29, 2008

(54) CHANGE VERIFICATION IN A CONFIGURATION MANAGEMENT DATABASE

(75) Inventor: David L. Kaminsky, Chapel Hill, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/534,824

(22) Filed: Sep. 25, 2006

(51) Int. Cl. G06F 12/16

(52) U.S. Cl. 707/203; 707/E17.005; 711/E12.103

(57) ABSTRACT

Embodiments of the present invention address deficiencies of the art in respect to configuration changes in a network architecture and provide a method, system and computer program product for change verification using a configuration management database (CMDB). In one embodiment of the invention, a change verification method can be provided. The method can include receiving a proposed configuration change for application to a CMDB, cloning at least a portion of the CMDB to produce a clone, applying the proposed configuration change to the clone, and evaluating the clone as modified by the proposed configuration change. Thereafter, the proposed configuration change can be applied to a resource referenced by the clone based upon the evaluation.

### BACKGROUND OF THE INVENTION

1. Field of the Invention

The present invention relates to the field of enterprise computing and network administration, and more particularly to the operation and management of a configuration management database (CMDB).

2. Description of the Related Art

The task of modern network administration differs significantly from that of days gone by. Not just a decade ago, network administration primarily entailed the addition and deletion of network users, the management of print queues, and the supervision and operation of daily backup procedures. Most if not all resources required by network applications remained present in the network itself, and few if any network applications depended upon the operation of other, co-executing applications.

Much has changed since the early days of network computing. Today, enterprise computing permeates the electronic landscape. While some enterprise applications remain largely stand-alone, most rely in some respect on a co-existing enterprise application or a soft enterprise resource, such as a database application, Web application server, or other cooperating component. Thus, the administration of the network has advanced far beyond user and print queue administration and daily backup routines. Today, the inter-dependencies among network components present a significant challenge to the network administrator. In this regard, the management of a single network component can depend upon the state of a multiplicity of other network components.

Changing components or configuration settings with a network architecture requires careful consideration of the potential impact of a given change. System changes generally are known to be the source of architectural missteps in even the simplest of network structures. As system complexity increases, however, the number of errors caused by a configuration change increases exponentially. The advent of the configuration management database (CMDB) acts to remediate the foregoing problem and creates an opportunity to help identify and prevent potential errors.

A CMDB is a unified or federated repository of information related to all the components of an information system. A CMDB provides a view to the information technology manager of an organization in order to understand the relationships between the components of the information system. The CMDB further facilitates the monitoring and management of the configuration of the components of the information system. Component and relationship information imported from information technology (IT) management systems into a CMDB can be provided in XML documents. Examining the content of an XML document used to import information from an IT management system into a CMDB will reveal that subsets of components are linked together by relationships. Furthermore, in examining all of the components linked by a set of relationships, a set of data graphs can be constructed where the nodes of the graphs represent the components and the connectors represent the relationships.

### BRIEF SUMMARY OF THE INVENTION

Embodiments of the present invention address deficiencies of the art in respect to configuration changes in a network architecture and provide a novel and non-obvious method, system and computer program product for change verification using a CMDB. In one embodiment of the invention, a change verification method can be provided. The method can include receiving a proposed configuration change for application to a CMDB, cloning at least a portion of the CMDB to produce a clone, applying the proposed configuration change to the clone, and evaluating the clone as modified by the proposed configuration change. Thereafter, the proposed configuration change can be applied to a corresponding resource referenced by the clone based upon the evaluation. As it is to be recognized by the skilled artisan, cloning refers to the copying of data in the CMDB—whether a mere portion of the data, or an entire collection of data.

In one aspect of the embodiment, cloning at least a portion of the CMDB to produce a clone, can include cloning the entire CMDB to produce a clone. In another aspect of the embodiment, evaluating the clone as modified by the proposed configuration change can include loading a set of configuration rules, evaluating data in the clone according to the set of configuration rules, and identifying any violations of the configuration rules in the set. Finally, in yet another aspect of the embodiment, the method further can include reporting the violations through a user interface, and permitting an application of the proposed configuration change to a corresponding resource referenced in the clone responsive to an affirmative approval provided through the user interface.

In another embodiment of the invention, a CMDB managed data processing system configured for change verification can be provided. The system can include a number of host computing systems hosting a number of applications. The system also can include a change management host coupled to the host computing systems over a computer communications network, and a CMDB coupled to the change management host. Finally, the system can include change verification logic coupled to the change management host.

The change verification logic can include program code enabled to receive a proposed configuration change for application to the CMDB and to clone at least a portion of the CMDB to produce a clone. The program code further can be enabled to apply the proposed configuration change to the clone and to evaluate the data in the clone as modified by the proposed configuration change. Finally, the program code yet further can be enabled to apply the proposed configuration change to a corresponding resource referenced in the clone based upon the evaluation.

In one aspect of the embodiment, the system also can include a set of configuration rules. In this regard, the change verification logic can include additional program code enabled to compare the clone as modified to the set of configuration rules, and to identify any violations of the configuration rules in the set. For example, the set of configuration rules can include rules specifying acceptable levels of firmware parameter settings. As another example, the set of configuration rules can include rules specifying acceptable levels of application-level parameter settings.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a data processing system configured for CMDB based change verification; and,

FIG. 2 is a flow chart illustrating a process for CMDB based change verification.

### DETAILED DESCRIPTION OF THE INVENTION

Embodiments of the present invention provide a method, system and computer program product for change verification using a CMDB. In accordance with an embodiment of the present invention, prior to applying configuration changes to the CMDB, a clone of an affected portion of the CMDB, or the CMDB in its entirety, can be created. Thereafter, the proposed configuration changes can be applied to the clone and compared to a set of rules to determine whether the proposed configuration changes are permitted. If so, the proposed configuration changes can be applied to the CMDB. Otherwise, the configuration changes can be discarded.

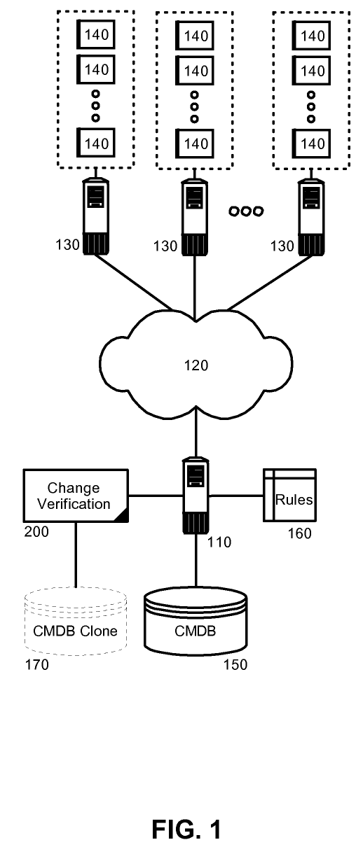

In more particular illustration, FIG. 1 is a schematic illustration of a data processing system configured for CMDB based change verification. As shown in FIG. 1, a network data processing system can include one or more host computing systems 130 coupled to one another over a computer communications network 120. Each of the host computing systems 130 can support the operation of one or more computing applications 140. The computing applications 140 can range from directed computing solutions addressing particular end user business needs, to utility applications addressing the management of the data processing system itself, to core computing applications such as application servers, content servers, file servers, operating systems, and the like.

A change management host 110 can be coupled to the host computing systems 130 over the computer communications network 120. The change management host 110 can further be coupled to a CMDB 150. Notably, change verification logic 200 can be coupled to the change management host 1 10. The change verification logic 200 can include program code enabled to manage proposed configuration changes to the data processing system by first creating a clone 170 of the CMDB 150 and applying the proposed configuration changes to the clone 170. Thereafter, the program code of the change verification logic 200 can exercise one or more change verification rules 160 against the proposed changes in the clone 170 in order to determine whether to allow the application of the proposed changes to the CMDB 150.

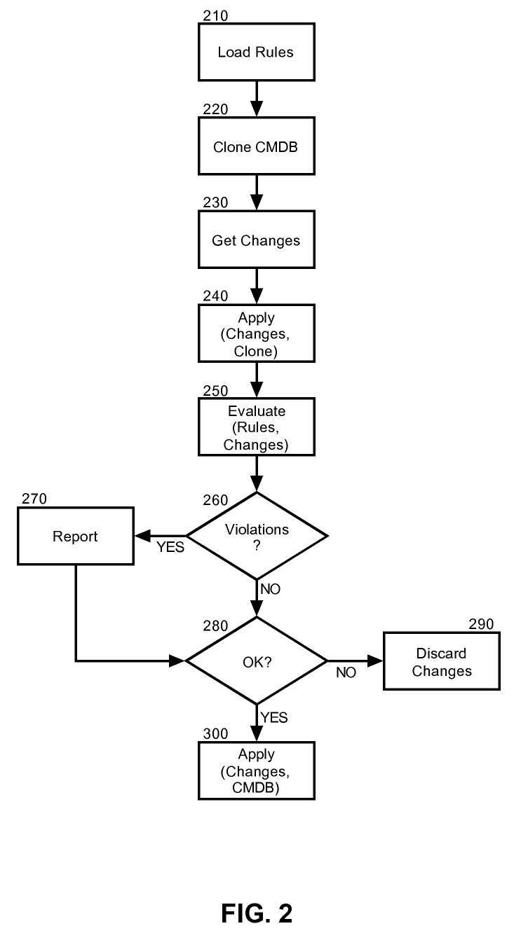

In further illustration, FIG. 2 is a flow chart illustrating a process for change verification using a CMDB. Responsive to a request to apply a change in configuration to a portion of a coupled data processing system, beginning in block 210, one or more change verification rules can be loaded and in block 220, the entirety of the CMDB, or merely an applicable portion of the CMDB can be cloned. In block 230, the proposed configuration changes can be received for processing. Thereafter, the proposed configuration changes can be applied to the clone. Once applied, the configuration changes in the clone can be evaluated in view of the loaded rules.

The loaded rules can specify acceptable levels of firmware, or application-level parameter settings. As such, the evaluation of the configuration changes in the clone in view of the loaded rules can result in any or no violations. In decision block 260, if violations are detected, in block 270 the violations can be reported through a user interface. In decision block 280, it can be determined whether the configuration changes have been approved. If so, the configuration changes can be applied to the CMDB in block 300. Otherwise, in block 290 the changes can be discarded.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A change verification method comprising:
receiving a proposed configuration change for application to a configuration management database (CMDB);
cloning at least a portion of the CMDB to produce a clone;
applying the proposed configuration change to the clone; and,
evaluating the clone as modified by the proposed configuration change.

2. The method of claim 1, further comprising proceeding to apply the proposed configuration change to a corresponding resource referenced by the clone based upon the evaluation

3. The method of claim 1, wherein cloning at least a portion of the CMDB to produce a clone, comprises cloning the entire CMDB to produce a clone.

4. The method of claim 1, wherein evaluating the clone as modified by the proposed configuration change, comprises:
loading a set of configuration rules;
evaluating data in the clone according to the set of configuration rules; and,
identifying any violations of the configuration rules in the set.

5. The method of claim 4, further comprising:
reporting the violations through a user interface; and,
permitting an application of the proposed configuration change to a resource referenced in the CMDB responsive to an affirmative approval provided through the user interface.

6. A configuration management database (CMDB) managed data processing system configured for change verification comprising:
a plurality of host computing systems hosting a plurality of applications;
a change management host coupled to the host computing systems over a computer communications network;
a CMDB coupled to the change management host; and,
change verification logic coupled to the change management host, the change verification logic comprising program code enabled to receive a proposed configuration change for application to the CMDB, clone at least a portion of the CMDB to produce a clone, apply the proposed configuration change to a corresponding resource referenced by the clone, evaluate the clone as modified by the proposed configuration change, and apply the proposed configuration change to the CMDB based upon the evaluation.

7. The system of claim 6, further comprising a set of configuration rules, the change verification logic comprising additional program code enabled to compare the clone as modified to the set of configuration rules, and to identify any violations of the configuration rules in the set.

8. The system of claim 7, wherein the set of configuration rules comprise rules specifying acceptable levels of firmware parameter settings.

9. The system of claim 7, wherein the set of configuration rules comprise rules specifying acceptable levels of application-level parameter settings.

10. The system of claim 7, wherein the clone is a clone of the CMDB.

11. The system of claim 7, wherein the clone is a clone of a portion of the CMDB.

12. A computer program product comprising a computer usable medium embodying computer usable program code for change verification, the computer program product including:
computer usable program code for receiving a proposed configuration change for application to a configuration management database (CMDB);
computer usable program code for cloning at least a portion of the CMDB to produce a clone; and,
computer usable program code for applying the proposed configuration change to the clone.

13. The computer program product of claim 12, further comprising computer usable program code for proceeding to apply the proposed configuration change to a corresponding resource referenced by the clone based upon the evaluation.

14. The computer program product of claim 12, wherein the computer usable program code for cloning at least a portion of the CMDB to produce a clone, comprises computer usable program code for cloning the entire CMDB to produce a clone.

15. The computer program product of claim 12, wherein the computer usable program code for evaluating the clone as modified by the proposed configuration change, comprises:
computer usable program code for loading a set of configuration rules;
computer usable program code for evaluating data in the clone according to the set of configuration rules; and,
computer usable program code for identifying any violations of the configuration rules in the set.

16. The computer program product of claim 15, further comprising:
computer usable program code for reporting the violations through a user interface; and,
computer usable program code for permitting an application of the proposed configuration change to the CMDB responsive to an affirmative approval provided through the user interface.
